(19) United States
(12) Patent Application Publication
(10) Pub. No.: US 2003/0016023 A1
(43) Pub. Date: Jan. 23, 2003

(54) Method for determining the state of charge of rechargeable batteries

(75) Inventors: Gerolf Richter, Hildesheim (DE); Ingo Koch, Hameln (DE)

Correspondence Address: SCHNADER HARRISON SEGAL & LEWIS, LLP, 1600 MARKET STREET, SUITE 3600, PHILADELPHIA, PA, 19103

(73) Assignee: VB Autobatterie GmbH, Hannover (DE)

(21) Appl. No.: 10/192,240

(22) Filed: Jul. 10, 2002

(30) Foreign Application Priority Data
Jul. 11, 2001 (DE) DE 101 33 806.6

(51) Int. Cl. G01N 27/416

(52) U.S. Cl. 324/427

(57) ABSTRACT

A method for determining the state of charge of rechargeable batteries by measuring the rechargeable battery voltage and comparing it with predetermined families of characteristic curves, the rechargeable battery voltage U_{Bi}, the charging time t_{Li} and, from comparison with characteristic curves ΔQᵢ=f(SOC,t_{L},U_{B}) the charge increase are determined in each charging phase. In a subsequent discharge phase, the rechargeable battery voltage U_{Bi} is measured in time intervals, a rechargeable battery voltage value U_{Bij+1} at the end of a time interval is determined from the rechargeable battery voltage U_{Bij} at the beginning of the time interval by means of an assumed current value I_{Bij} by comparison with families of characteristic curves U_{B}=f(I_{B},Rᵢ,SOC), and a corrected current value I_{Bij+1} is determined by iteration from the deviation of the value thus determined of U_{Bij+1} and the rechargeable battery voltage actually measured at the end of the time interval. The loss of charge is calculated from I_{Bij+1}. During the charging phase and the discharge phase, the rechargeable battery temperature T is measured and the comparison is effected with families of characteristic curves which contain the rechargeable battery temperature T as an additional variable.

### RELATED APPLICATION

This application claims priority of German Patent Application No. DE 101 33 806.6, filed Jul. 11, 2001.

### FIELD OF THE INVENTION

This invention relates to a method for determining the state of charge of rechargeable batteries by measuring the rechargeable battery voltage and comparing it with predetermined families of characteristic curves.

### BACKGROUND

Identifying the rechargeable battery state, in particular, of starter batteries during the operation of motor vehicles with an internal combustion engine, is of considerable importance. In known methods for recognizing that state, use is made of computer-aided methods which, like DE 19847648 A1, for example, are based on charge balancing. In other methods, the transfer response of the battery is used by means of an equivalent circuit diagram or mathematical model. By way of example, it is known (Willibert Schleuter: etzArchiv Vol. 4 (1982) 1.7; P. Lüirkens, W. Steffens, etzArchiv Vol. 8 (1986) 1.7), to assume, for a battery, a simple equivalent circuit diagram whose parameters are learned by analysis of battery behavior during operation and which then allows prediction of future behavior. This requires voltage and current at the battery to be continually acquired and processed, e.g., in a computer.

For the realization of both approaches, however, it is necessary, in addition to determining the present rechargeable battery voltage and the rechargeable battery temperature, also to continuously measure the rechargeable battery current as accurately as possible. Particularly in the case of exact current measurement, however, it is necessary to implement a considerable technical outlay because the starter battery current interval, with relevance to the state of charge, in modern vehicles extends from a few mA for the quiescent current loads through to almost 1000 A short-circuit current at the beginning of the starting process.

In this respect, besides the already existing methods, there is a need for a method which dispenses with continuous current measurement over the entire battery current spectrum for determination of the state of charge.

Therefore, it would be advantageous to provide a means of estimating the state of charge of rechargeable batteries during operation in a vehicle with sufficient reliability and of dispensing with complicated current measurements in the process.

### SUMMARY OF THE INVENTION

This invention relates to a method for determining the state of charge of a rechargeable battery including measuring rechargeable battery voltage U_{Bi} at a selected charging time t_{Li} in each charging phase; determining charge increase by comparing battery voltage U_{Bi} with characteristic curves ΔQi=f(SOC,t_{L},U_{B}); measuring rechargeable battery voltage U_{Bi} at selected time intervals in a subsequent discharge phase; determining a rechargeable battery voltage value U_{Bij+1} at the end of a selected time interval from a rechargeable battery voltage U_{Bij} at the beginning of the selected time interval from an assumed current value I_{Bij} by comparison with families of characteristic curves U_{B}=f(I_{B},Rᵢ,SOC); determining a corrected current value I_{Bij+1} by iteration from deviation of a value determined for U_{Bij+1} and battery voltage actually measured at the end of the time interval; and calculating the loss of charge from I_{Bij+1}.

### BRIEF DESCRIPTION OF THE DRAWINGS

The method is explained in more detail below with reference to the figures:

FIG. 1 is a graph diagrammatically showing the profile of a rechargeable battery voltage U_{B} during charging and discharging.

FIGS. 2a, b and c are graphs diagrammatically showing the dependence of a charge increase ΔQ on charging time t_{L}, charging voltage U_{B} and state of charge SOC (FIGS. 2a, 2b) and the dependence on the rechargeable battery temperature T (FIG. 2c).

FIG. 3 is a graph showing a diagram for the procedure according to the invention for determining the loss of charge during discharging.

### DETAILED DESCRIPTION

In the method according to the invention, in order to estimate the state of charge of a battery installed in a motor vehicle, by evaluation of the temporal profile of battery voltage and battery temperature, the charge increase is determined as an integral value at the end of the charging phase, whereas the loss of charge is in each case determined after a measurement or computation time interval has elapsed, accompanying the discharge, until the end of the discharge phase. The beginning of the “charging” battery operating phase is defined by the current zero crossing from the discharge phase and the beginning of the “discharging” battery operating phase is defined by the current zero crossing from the charging phase.

The charge increase during the charging phase is gathered from a value range matrix whose axes are characterized by the charge voltage, the state of charge at the instant of the current zero crossing from the discharge phase, the temporal duration of the charging phase and the battery temperature during the charging phase.

In one refinement of the invention, during the discharge phase, the temporal profile of the loss of charge is determined in iterative form after a respective time interval Δt has elapsed, a battery voltage for the instant after the time interval Δt has elapsed being determined with the aid of at least one calculation equation from the values for the expected current and the expected battery internal resistance, which values are firstly estimated for the end of the next measurement and computation interval, which battery voltage is then compared with the measured battery voltage. The information obtained from this comparison is used to improve the estimated values for current and internal resistance, which in turn leads to a reduction of the difference between the measured voltage value and the value thus calculated in the last iteration step. This process is terminated when a sufficient accuracy is present and the current thus estimated is used for determining the loss of charge.

In a further refinement of the invention, during the discharge phase, the temporal profile of the loss of charge is determined after a respective time interval Δt has elapsed, firstly different values for the expected current and the expected battery internal resistance being assumed for the end of the next measurement and computation interval and different values for the battery voltage after the time interval Δt has elapsed thus being calculated using a calculation equation. Using these voltage values and the information about the profile of these voltage values in dependence on the assumed current values and the voltage value measured after the time interval has elapsed, the flowing current is estimated and the current thus estimated is used for determining the loss of charge.

The required internal resistance value is gathered from a value range matrix which depends at least on the battery temperature, the charge content and the battery current. In addition, in the discharge phase, besides the battery internal resistance, the voltage drop on account of the drawn charge and the change in the quiescent voltage on account of the drawn charge can be used for calculating voltage values.

In order to increase the accuracy, interpolation is effected, if appropriate, between the quantities of the value range matrices.

The charge content of the battery is determined from the battery voltage determined at the current zero crossing by means of a value range matrix in which the charge content is represented at least in dependence on the battery voltage and the battery temperature. The battery voltage at the instant of the current zero crossing is measured for example with a +/−tolerance variation of 0.5 mV. The calculated present charge content can be controlled and corrected after the end of a discharge cycle by the battery voltage at the current zero crossing. Instead of the value range matrices, it is possible to use empirical equations, or the empirically determined families of characteristic curves can be replaced by polynomial equations derived therefrom.

The typical sequence of charge and discharge phases for starter batteries in a motor vehicle can be ideally described by plotting the battery voltage U_{B} against the battery current I_{B}. This produces a curve trace which is closed in a loop-shaped manner and is illustrated in FIG. 1 and the beginning of which, after the vehicle has been at a standstill for a number of hours, lies almost at zero on the current axis, depending on the magnitude of the quiescent current consumption and, on the voltage axis, lies in the vicinity of the quiescent voltage characteristic of the state of charge, U₀.

The longer the time beforehand during which the vehicle is at a standstill, the better the relationship between U₀ and the state of charge of the rechargeable battery.

After the vehicle has been started, both the charging current and the battery voltage rise until the maximum prescribed generator regulator voltage is reached, if the current production exceeds the current demand in the on-board electrical system. Otherwise, a discharge current (negative sign) flows and the battery voltage decreases.

However, if the battery is in the charging region during the i-th cycle and the charging current falls back for reasons of lower current supply and/or increased consumption, then the current/voltage curve, before it changes to the discharge region, passes through the point I_{B}=0 where U_{B}=U_{Lei}. (Charging L to discharging E). This current zero crossing with the voltage U_{LEI} at the instant t_{LEi} thus characterizes the change from the i-th charging cycle to the i-th discharge cycle.

If the current balance for the battery improves again in the further course of the subsequent i-th discharge cycle, then the current/voltage curve passes through a minimum before it performs the change to the (i+1)-th charging phase. During this change, the battery current tends toward zero again (I_{B}=0) and the voltage assumes the value U_{B}=U_{ELI+1}. The battery voltage U_{ELi+1} thus characterizes the current zero crossing from the discharge region to the charging region at the instant t_{ELi+1}.

According to the invention, for recognizing the state of charge of rechargeable batteries, in particular of starter batteries, the procedure is as follows.

Charging phase

A vehicle battery is in the state of charge acceptance if there is a temporary surplus of generator current in the on-board electrical system. This situation arises whenever the prevailing generator rotational speed, as a consequence of the respective driving situation, permits the generation of a current which is greater than that required by the sum of all the electrical loads at the same instant. In this respect, the risk of the electrical undersupply of individual loads in the on-board electrical system is precluded during the battery charging phase. Therefore, in the method according to the invention, the gain in charge ΔQ during such a battery charging phase i, which is thus noncritical with regard to the electrical supply of the vehicle, is not determined at every instant t of the i-th charging process, but rather is only specified as integral value at the end, i.e., upon the change to the discharge region at the instant t_{LEi}.

The value for ΔQᵢ, charge increase in the i-th charging phase, results from a multidimensional value range matrix as a function of the quantity of charge situated in the battery at the instant of the i-th charging beginning t_{ELi} or of the state of charge SOCᵢ₋₁, the i-th charging interval duration t_{Li}=t_{LEi}−t_{ELI} and advantageously the average battery temperature Tᵢ during the i-th charging process. The following thus holds true for the value—gathered from the matrix—for the charge increase in the i-th charging interval:

ΔQᵢ=f(SOC₋₁, t_{Li}, Tᵢ) (1)

The charging voltage can also be taken into account as a variable in the form of a further matrix dimension.

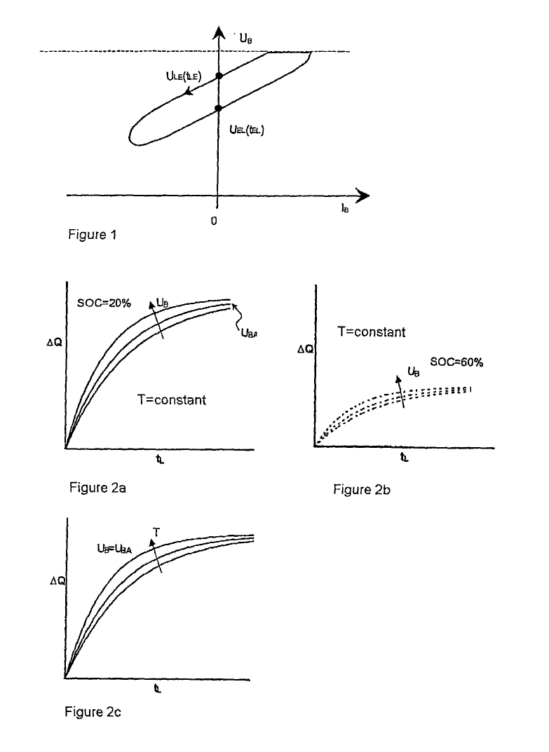

FIG. 2 illustrates corresponding characteristic curves ΔQ in dependence on U_{B} and SOC (FIGS. 2a, 2b). FIG. 2c shows the dependence on the rechargeable battery temperature T for the voltage U_{BA} selected from FIG. 2a. These relationships can also be mapped by a function which is empirical, standardized and thus valid for all starter battery sizes of a type series with similar construction. Discharge phase

Since, in principle, at any arbitrary instant t of the i-th discharge phase of a vehicle battery, there is a supply risk for the electrical loads of the on-board electrical system and this risk increases more than proportionally in particular in the case of low states of charge, in contrast to the charging phase it is necessary to determine the change in charge at every instant as ΔQᵢ(t). According to the invention, this change in the state of charge is determined according to the following method:

What is used as a basis is the relationship

U_{B}(t)=U₀(t)−R(t)·I_{B}(t), (2)

which links the present battery voltage U_{B}(t) with the quiescent voltage U₀(t), which is influenced by the present charge content Q(t), and the quantities battery internal resistance R(t) and battery current I_{B}(t).

If the relationship (2) is then formed in each case at two instants tᵢⱼ and tᵢⱼ₊₁ that directly succeed one another shortly by Δt in the i-th discharge interval, then the determination specification according to the invention results from the difference between these two equations:

U_{Bij}−U_{Bij+1}=U₀ᵢⱼ−U₀ᵢⱼ₊₁−(I_{Bij}−I_{Bij+1})Rᵢⱼ. (3)

Transformation of the relationship (3) taking account of an additional term leads to a calculation equation for the (j+1)-th time interval, whose variables still require more precise definition:

$${U}_{Bij + 1} = {U}_{Bij} + {R}_{ij} ( {I}_{Bij} - {I}_{Bij + 1} ) + Δ {U}_{Oij} + \frac{ⅆ {U}_{Bij}}{ⅆ t} \cdot Δ t \qquad ( 4 )$$

In this case, Rᵢⱼ is dependent on the presently prevailing battery temperature Tᵢⱼ, the present state of charge SOCᵢⱼ and the two currents I_{Bij} and I_{Bij+1} The following holds true:

Rᵢⱼ=f(Tᵢⱼ, SOCᵢⱼ, I_{Bij}, I_{Bij+1}) (5)

The quantity dU_{Bij}/dt results from a value range matrix depending on flowing current, the battery temperature and the state of charge and takes account of the change in voltage for a constant discharge current.

If the rechargeable battery voltage and the rechargeable battery temperature are observed over their profile during the i-th battery discharge phase, the quantities for the current and the internal resistance or the changes thereof are not known for the respective last observation interval tᵢⱼ to tᵢⱼ₊₁—only the new battery voltage can be determined by measurement. For a solution, in such cases an iterative process is used in which firstly a current for the instant tᵢⱼ₊₁ is estimated, with the aid of which the new internal resistance can then be determined. According to equation (4), a new rechargeable battery voltage is then calculated and it is subsequently ascertained how the latter corresponds to the rechargeable battery voltage actually measured. Depending on the deviation, the current value I_{Bij+1} is then corrected and a new rechargeable battery voltage is calculated. This iterative process is run through until the deviation is better than a predeterminable value ε. The drawn charge then results as:

Qᵢⱼ₊₁=Qᵢⱼ−Δt(I_{Bij}+I_{Bij+1})/2. (6)

Afterward, the next discharge step tᵢⱼ₊₂ is analyzed according to the same method.

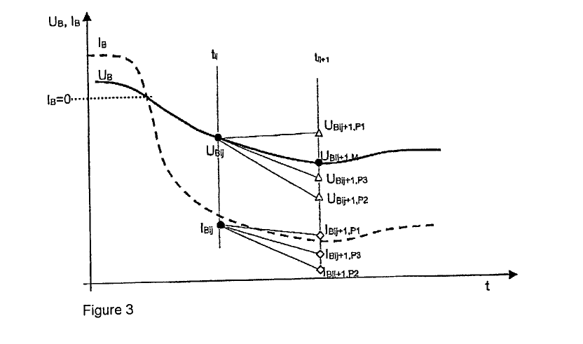

As illustrated in FIG. 3, the above method for determining the unknown parameters for the next discharge time step in each case can also be determined by a set of N equations of the type (4). With this kind of procedure, the method becomes significantly more efficient and more accurate, but this initially also presupposes the estimation of a set of N battery currents.

The procedure for three different currents is illustrated by way of example in FIG. 3.

For the (j+1)-th time step, firstly three currents are estimated under the assumption of a known current value at the j-th time step

I_{Bij+1,P1}=F₁(I_{Bij})

I_{Bij+1,P2}=F₂(I_{Bij}) (7)

I_{Bij+1,P3}=F₃(I_{Bij})

Afterward, a set of battery voltages is calculated for the different current values based in each case on equation (4).

The battery resistance R_{ij,1 . . . 3}, which is applicable in the current range between I_{Bij} and I_{Bij+1,P1 . . . 3}, is determined as a mean value from the resistances for the currents I_{Bij} and I_{Bij+1,P1 . . . 3} from a value range matrix over the current, the battery temperature T and the state of charge Q_{ij,1 . . . 3}. The voltage gradient dU_{Bij+1,1 . . . 3}/dt is likewise determined from a family of characteristic curves from battery temperature, the current and the state of charge. The voltage gradient dU_{Bij+1}/dt can be dispensed with depending on the requirement made of the accuracy of the method.

One possibility for estimating the current and the voltage value is as follows:

From the three calculated value pairs (U_{Bij+1,P1 . . . 3},I_{Bij+1,P1 . . . 3}), a suitable regression curve I_{Bij+1,P}=f(U_{Bij+1,P}) is calculated by least mean square error method. The current value I_{Bij+1} is then calculated as I_{Bij+1}=f(U_{Bij+1}). The value U_{Bij+1} results from the measured value U_{Bij+1,M}, in the simplest case by equating, but it is expedient for the value U_{Bij+1,M} also to be filtered beforehand.

The advantages over previously known methods for determining the state of charge of a starter battery in a motor vehicle reside in the fact that the determination of the state of charge of the battery is carried out at every instant, that is to say, in its temporal profile, only during the discharge phase which is critical for the vehicle. This represents a significant simplification and obviates the complicated and/or inaccurate measurement of the battery current.

By contrast, the gain in charge during the battery charging phase which is noncritical with regard to the electrical supply of the vehicle, is specified as an integral value in each case at the end of this process.

In order to determine this integral charge acceptance, either multidimensional value range matrices or empirical mathematical equations which are standardized to the rated capacity of the battery are used, whose variables are in both cases the quantities state of charge at the beginning of charging, electrolyte or battery temperature and the charging time interval. The charging voltage can additionally be taken into account.

In order to acquire the temporal profile—in contrast to the charging phase—of the discharge current and thus of the state of charge as a function of time, the new method makes use of an iterative method which manages solely with the measurement quantities rechargeable battery voltage, rechargeable battery temperature and the state of charge known from the charging phase. In addition, the method is based on values which are stored in families of characteristic curves or defined as empirical equation for the rechargeable battery internal resistance and the quiescent voltage as functions of the rechargeable battery temperature, for example, electrolyte temperature, the presently estimated current calculated in the last iteration step, and the charge content determined by the same method. In the case of each iterative step by Δt on the time axis, the parameters R and U₀ are determined with the aid of initially estimated rechargeable battery currents, with the aid of which parameters the expected new rechargeable battery voltage U_{B,P} can be calculated. With sufficient accuracy, the new charge content is calculated from the current thus determined or from the change in the state of charge.

The state of charge thus determined is controlled and corrected at the end of the discharge phase at the instant of the current zero crossing from discharge region to the charging region. The rechargeable battery voltage determined at this instant is assessed as a measure of the state of charge with known rechargeable battery temperature. In addition to this cyclic control of the respectively determined state of charge by a voltage measurement and the evaluation thereof at the instant of the change from the discharge phase to the charging phase, a system reset is effected within the so-called quiescent phase with the internal combustion engine switched off.

1. A method for determining the state of charge of rechargeable batteries by measuring the rechargeable battery voltage and comparing it with predetermined families of characteristic curves, characterized in that the rechargeable battery voltage U_{Bi}, the charging time t_{Li} and, from comparison with characteristic curves ΔQ₁=f(SOC,t_{L},U_{B}) the charge increase are determined in each charging phase, and in that, in a subsequent discharge phase, the rechargeable battery voltage U_{Bi} is measured in time intervals, in that a rechargeable battery voltage value U_{Bij+1} at the end of a time interval is determined from the rechargeable battery voltage U_{Bij} at the beginning of the time interval by means of an assumed current value I_{Bij} by comparison with families of characteristic curves U_{B}=f(I_{B},Rᵢ,SOC), and in that a corrected current value I_{Bij+1} is determined by iteration from the deviation of the value thus determined of U_{Bij+1} and the rechargeable battery voltage actually measured at the end of the time interval and the loss of charge is calculated from I_{Bij+1}.

2. The method according to claim 1, characterized in that, during the charging phase and the discharge phase, the rechargeable battery temperature T is measured and the comparison is effected with families of characteristic curves which contain the rechargeable battery temperature T as an additional variable.

3. The method according to claim 1, characterized in that the rechargeable battery voltage drop during the time interval is taken into account in the determination of the rechargeable battery voltage value U_{Bij+1}.

4. The method according to claim 1, characterized in that the initial value of SOC is determined from the function SOC=f(U_{EL},T) by measuring the rechargeable battery voltage U_{EL} during the transition from discharging to charging.

5. The method according to claim 1, characterized in that the families of characteristic curves are replaced by polynomial equations derived from them.

6. The method according to claim 1, characterized in that the rechargeable battery is a lead acid rechargeable battery.

7. The method according to claim 1, characterized in that the families of characteristic curves are determined empirically.

8. A method for determining the state of charge of a rechargeable battery comprising:
measuring rechargeable battery voltage U_{Bi} at a selected charging time t_{Li} in each charging phase;
determining charge increase by comparing battery voltage U_{Bi} with characteristic curves ΔQᵢ=f(SOC,t_{L},U_{B});
measuring rechargeable battery voltage U_{Bi} at selected time intervals in a subsequent discharge phase;
determining a rechargeable battery voltage value U_{Bij+1} at the end of a selected time interval from a rechargeable battery voltage U_{Bij} at the beginning of the selected time interval from an assumed current value I_{Bij} by comparison with families of characteristic curves U_{B}=f(I_{B},Rᵢ,SOC);
determining a corrected current value I_{Bij+1} by iteration from deviation of a value determined for U_{Bij+1} and battery voltage actually measured at the end of the time interval; and
calculating the loss of charge from I_{Bij+1}.

9. The method according to claim 8, wherein, during the charging phase and the discharge phase, the rechargeable battery temperature T is measured and the comparison is effected with families of characteristic curves which contain the rechargeable battery temperature T as an additional variable.

10. The method according to claim 8, wherein the rechargeable battery voltage drop during the selected time interval is taken into account in determining the rechargeable battery voltage value U_{Bij+1}.

11. The method according to claim 8, wherein an initial value of SOC is determined from SOC=f(U_{EL},T) by measuring rechargeable battery voltage U_{EL} during a transition from discharging to charging.

12. The method according to claim 8, wherein the families of characteristic curves are replaced by polynomial equations derived therefrom.

13. The method according to claim 8, wherein the rechargeable battery is a lead acid rechargeable battery.

14. The method according to claim 8, wherein the families of characteristic curves are determined empirically.
